(19) United States
(12) Patent Application Publication
(10) Pub. No.: US 2012/0014735 A1
(43) Pub. Date: Jan. 19, 2012

(54) PRINTER AND ROLL

(75) Inventor: Takeshi Tashiro, Shizuoka (JP)

(73) Assignee: TOSHIBA TEC KABUSHIKI KAISHA, Tokyo (JP)

(21) Appl. No.: 13/033,705

(22) Filed: Feb. 24, 2011

(30) Foreign Application Priority Data
Jul. 15, 2010 (JP) 2010-160282

(51) Int. Cl. B41J 11/42

(52) U.S. Cl. 400/583

(57) ABSTRACT

According to one embodiment, a printer is provided which includes a roll holding unit, an irradiation unit, a light-receiving unit, an identification unit, a control unit, and a print unit. The roll holding unit is configured to hold a roll wound with a web material. The irradiation unit is configured to irradiate light on at least a portion of the web material wound around the roll. The light-receiving unit is configured to receive light reflected from the at least a portion of the web material. The identification unit is configured to identify whether an identifier is provided on the web material and whether the identifier is valid, based on the light reception result of the light-receiving unit. The control unit, in response to the identification results of the identification unit, is configured to perform a predetermined operation according to an operation mode or change the operation mode. The print unit is configured to print on a printing medium based on the operation mode.

### CROSS-REFERENCE TO RELATED APPLICATIONS

This application is based upon and claims the benefit of priority from Japanese Patent Application No. 2010-160282, filed on Jul. 15, 2010, the entire content of which is incorporated herein by reference.

### FIELD

Embodiments described herein relate generally to a printer and a roll.

### BACKGROUND

In the related art, there is known a printer which holds rolls of an ink ribbon and a printing medium to print on the medium.

In such a printer, if counterfeit products of an ink ribbon and a printing medium are used, they may cause deterioration of the print quality or malfunction of the printer.

### BRIEF DESCRIPTION OF THE DRAWINGS

FIG. 1 is a diagrammatic side-elevational view showing an internal configuration of an illustrative embodiment of a printer.

FIG. 2 is a block diagram showing one example of a control circuit in an illustrative embodiment of a printer.

FIG. 3 is a block diagram showing one example of a control unit in an illustrative embodiment of a printer.

FIG. 4 is a perspective view of one example of an ink ribbon roll according to an illustrative embodiment.

FIG. 5 is a perspective view of one example of a strip-shaped paper roll according to an illustrative embodiment.

### DETAILED DESCRIPTION

According to one embodiment, a printer is provided which includes a roll holding unit, an irradiation unit, a light-receiving unit, an identification unit, a control unit, and a print unit. The roll holding unit is configured to hold a roll wound with a web material (e.g., a strip-shaped material). The irradiation unit is configured to irradiate light on at least a portion of the web material wound around the roll. The light-receiving unit is configured to receive light reflected from the at least a portion of the web material. The identification unit is configured to identify whether an identifier is provided on the web material and whether the identifier is valid, based on the light reception result of the light-receiving unit. The control unit, in response to the identification results of the identification unit, is configured to perform a predetermined operation according to an operation mode or change the operation mode. The print unit is configured to print on a printing medium based on the operation mode.

Embodiments will now be described in detail with reference to the drawings.

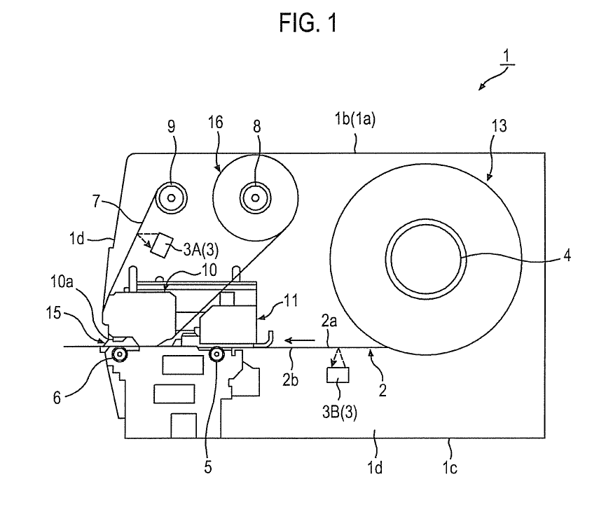

As shown in FIG. 1, a printer 1 of an illustrative embodiment may print on a label (used as a printing medium), which is provided on (e.g., adhered to) an inner surface 2a of a web material 2 (e.g., paper). In some embodiments, the printer 1 may perform printing on a printing medium other than a label, for example, a continuous-form paper without a backing sheet. In addition, the printer 1 may have a function of writing and reading data to and from an RFID (Radio Frequency IDentification) chip attached on a label.

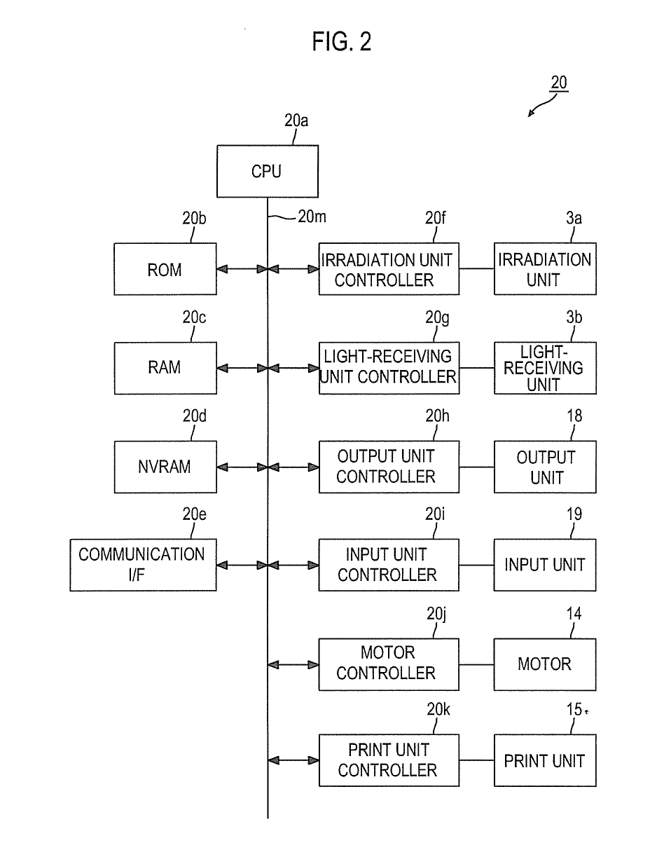

A main body 1a of the printer 1 includes a housing 1b with a bottom wall 1c and a side wall. The housing 1b includes a longitudinal wall 1d perpendicular to the bottom wall 1c and also parallel to the side wall. On the longitudinal wall 1d, a roll holding shaft 4, a conveying roller 5, a platen roller 6, a supply shaft 8 for an ink ribbon 7, a take-up shaft 9 for the ink ribbon 7, a print head block 10, a pinch roller block 11 and the like are mounted perpendicular to the longitudinal wall 1d. A control circuit 20 as shown in FIG. 2 is disposed on the rear side of the longitudinal wall 1d in the housing 1b, as seen in the plane of FIG. 1.

The roll holding shaft 4 rotatably holds a roll (e.g., paper roll) 13, around which the strip-shaped paper 2 is wound, in a state perpendicular to the plane of FIG. 1. In one embodiment, the roll holding shaft 4 may be rotatably supported by the longitudinal wall 1d. Alternatively, the roll holding shaft 4 may be fixed on the longitudinal wall 1d, thereby allowing the paper roll 13 wound with the strip-shaped paper 2 to rotate around the roll holding shaft 4. In any case, in this embodiment, the roll holding shaft 4 and the paper roll 13 are not driven by, for example, a motor. The paper roll 13 wound with the strip-shaped paper 2 rotates (or is driven) in conjunction with rotation of the conveying roller 5 and the platen roller 6, which are installed at the downstream side of the paper roll 13 in a paper feeding direction (the left direction in FIG. 1). As such, the strip-shaped paper 2 is discharged from the paper roll 13. In this embodiment, the strip-shaped paper 2 corresponds to a web material wrapped around the paper roll 13, and the roll holding shaft 4 corresponds to a roll holding unit.

The conveying roller 5 and the platen roller 6 is rotary-driven by means of, for example, a motor 14 (see FIG. 2). The conveying roller 5 is installed at the upstream side of the platen roller 6 and the print unit 15 in the paper feeding direction. The pinch roller block 11 includes a pinch roller (not shown) which is horizontally placed adjacent to the conveying roller 5 along the paper feeding direction. The pinch roller is biased toward the conveying roller 5 with a predetermined pressure. The strip-shaped paper 2, interposed between the conveying roller 5 and the pinch roller, is conveyed in the paper feeding direction along with rotation of the conveying roller 5. In this embodiment, the conveying roller 5, the platen roller 6, the motor 14, a motor controller 20j and the pinch roller block 11 may constitute a conveying mechanism.

A ribbon roll 16, around which a web material (e.g., ink ribbon 7) is wound, is held by the supply shaft 8 of the ink ribbon 7. A take-up shaft 9 is rotary-driven by means of, for example, the motor 14. With the rotation of the take-up shaft 9, the ink ribbon 7 is wound around the take-up shaft 9 while being discharged from the ribbon roll 16. Both the ink ribbon 7 and the strip-shaped paper 2 are interposed between a thermal head 10a contained in the print head block 10 and the platen roller 6. The thermal head 10a generates heat, which allows ink residing on the ink ribbon 7 to melt or sublimate. Through such operation of the thermal head 10a, a predetermined pattern such as a character, numeric character, bar code, or graphic, is transferred onto a label which is provided on (e.g., attached to) a surface of the strip-shaped paper 2, e.g., the inner surface 2a. Specifically, in this embodiment, a print mechanism includes the ink ribbon 7, the supply shaft 8, the take-up shaft 9, the print head block 10, the thermal head 10a, the motor 14, and the motor controller 20j. A print unit 15 includes the thermal head 10a and the platen roller 6. In this embodiment, the ink ribbon 7 corresponds to a web material wound around the ribbon roll 16, and the supply shaft 8 corresponds to a roll holding unit.

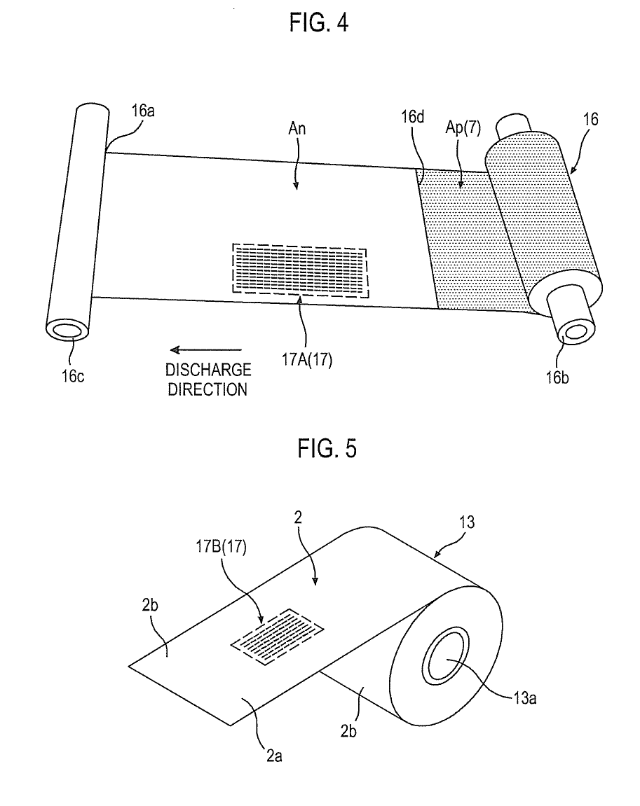

Further, in one embodiment, invisible identifiers 17A and 17B (collectively referred to as an invisible identifier 17) is provided on the strip-shaped paper 2 wound around the paper roll 13 and the ink ribbon 7 wound around the ribbon roll 16, respectively (see FIGS. 4 and 5). The invisible identifier 17 is provided on the surface of the strip-shaped paper 2 and the ink ribbon 7 by employing, for example, an ink (for example, a stealth ink that is invisible to human eyes) with an infrared absorbency or an infrared reflectivity, or an ink with a fluorescence (e.g., a fluorescent ink) which is visible under irradiation of infrared rays while it is invisible to human eyes. The invisible identifier 17 may include a bar code, a character, a symbol, a pattern, an image or the like.

The printer 1 includes optical units 3A and 3B (collectively referred to as an optical unit 3) for reading the invisible identifier 17. The optical unit 3A is operable to read an identifier 17A (see FIG. 4) provided on the ink ribbon 7, while the optical unit 3B is operable to read an identifier 17B (see FIG. 5) provided on the strip-shaped paper 2. Each of the optical units 3A and 3B includes an irradiation unit 3a and a light-receiving unit 3b (see FIG. 2). The irradiation unit 3a is operable to irradiate a region of the strip-shaped paper 2 or the ink ribbon 7 where the identifier 17 is provided, with infrared light or ultraviolet light, depending on the method of detecting respective identifier 17. The light-receiving unit 3b is operable to receive light reflected from the region of the strip-shaped paper 2 or the ink ribbon 7 where the identifiers 17B or 17A are provided respectively. For detection of the identifier 17 with an infrared absorbency or an infrared reflectivity, the light-receiving unit 3b may be implemented by employing, for example, an element which is capable of receiving light such as infrared light reflected from the identifier 17 and its peripheral portion. Likewise, for detection of the identifier 17 with a fluorescence, the light-receiving unit 3b may be implemented by employing, for example, an element which is capable of receiving light (e.g., visible light, infrared light, etc.) reflected off the identifier 17, which glows under IR or UV light. In one embodiment, the light-receiving unit 3b may be implemented with an image sensor such as CCD (Charge Coupled Device), CMOS (Complementary Metal Oxide Semiconductor) or the like, which may capture a two-dimensional image. In some embodiments, the light-receiving unit 3b may be implemented with a light-receiving element having a simpler structure. Furthermore, in one embodiment, additional ink or a sheet may be applied on the identifier 17 to enhance the invisibility of the identifier 17 so as to facilitate the optical unit 3 in reading the identifier 17. Moreover, a filter may be provided in the irradiation unit 3a or the light-receiving unit 3b if necessary. In this way, according to the embodiments, the invisible identifier 17 is provided on the strip-shaped paper 2 and the ink ribbon 7, which the printer 1 can identify, thereby preventing forgery of the paper roll 13 wound with the strip-shaped paper 2 or the ribbon roll 16 wound with the ink ribbon 7.

As shown in FIG. 2, the control circuit 20 in the printer 1 includes a CPU (Central Processing Unit) 20a, a ROM (Read Only Memory) 20b, a RAM (Random Access Memory) 20c, a NVRAM (Non-Volatile Memory) 20d, a communication interface (I/F) 20e, an irradiation unit controller 20f, a light-receiving unit controller 20g, an output unit controller 20h, an input unit controller 20i, the motor controller 20j and a print unit controller 20k, which are connected each other through a bus 20m such as an address or a data bus.

The CPU 20a deploys various computer-readable operation programs stored in the ROM 20b to the RAM 20c or the NVRAM 20d and executes the operation programs to control various components of the printer 1. The ROM 20b stores various kinds of data or programs (BIOS (Basic Input Output System), application programs, device driver programs or the like) that are executed by the CPU 20a. The RAM 20c temporarily stores data or programs while the CPU 20a executes various programs. The NVRAM 20d is operable to keep various kinds of data even in case of interruption of electric power, including, for example, reference data which is to be used for identification operations in an identification unit 21e, in addition to OS (Operating System), application programs, and device driver programs.

The communication I/F 20e controls data communication with another device connected through an electrical communication line.

The irradiation unit controller 20f controls the irradiation unit 3a in response to instructions from the CPU 20a. The light-receiving unit controller 20g controls the light-receiving unit 3b in response to instructions from the CPU 20a and transmit to the CPU 20a data obtained by optical-to-electrical conversion of light received at the light-receiving unit 3b.

The output unit controller 20h controls an output unit 18 (for example, a display, a light-emitting unit, a speaker, a buzzer) that outputs image or audio signals, in response to instructions from the CPU 20a. The input unit controller 20i controls an input unit 19 (for example, a push button, a touch panel, a keyboard, a microphone, a knob, a DIP switch) which receives audio input or allows a user to manually input a user instruction.

The motor controller 20j controls the motor 14, for example, a stepping motor, in response to instructions from the CPU 20a, to rotate. The motor controller 20j is further configured to send data indicative of a status of operation of the motor 14 to the CPU 20a.

The print unit controller 20k controls the thermal head 10a of the print unit 15 in response to instructions from the CPU 20a.

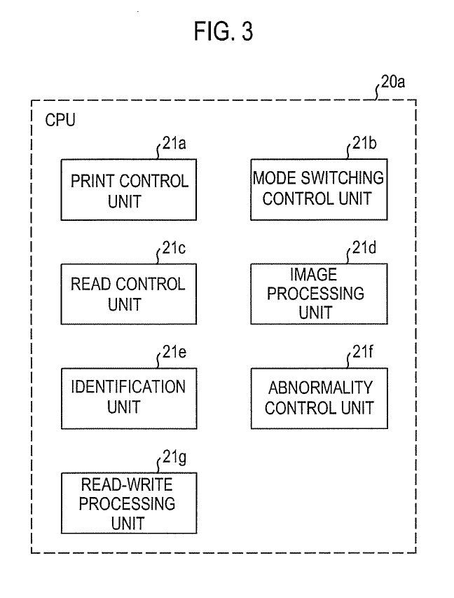

As shown in FIG. 3, according to programs, the CPU 20a may function as a number of control units including a print control unit 21a, a mode-switching control unit 21b, a read control unit 21c, an image processing unit 21d, the identification unit 21e, an abnormality control unit 21f, and a read-write processing unit 21g. The programs may include at least modules corresponding to the print control unit 21a, the mode-switching control unit 21b, the read control unit 21c, the image processing unit 21d, the identification unit 21e, the abnormality control unit 21f, and the read-write processing unit 21g.

The print control unit 21a allows the motor controller 20j and the print unit controller 20k to control the motor 14 and the print unit 15, respectively, so that predetermined information such as a character, an image or the like, is printed on the strip-shaped paper 2.

The mode-switching control unit 21b switches the operation of the printer 1 in response to a user instruction provided from the input unit 19 such as an operation button. For example, the printer 1 is configured to be operated in: a secure mode in which printing is performed only if the printer 1 is able to validly identify an identifier 17; an alarm mode in which the output unit 18 such as LED (Light Emitting Diode) outputs an indication of abnormality if the printer 1 is not able to validly identify an identifier 17; or a normal mode in which printing is performed irrespective of an identification of an identifier 17. In the printer 1 with the above configuration, the mode-switching control unit 21b switches operations of the print control unit 21a or the read control unit 21c in response to a user instruction provided from the input unit 19.

The read control unit 21c allows the irradiation unit controller 20f and the light-receiving unit controller 20g to respectively control the irradiation unit 3a and the light-receiving unit 3b, thereby obtaining data indicating a reception result at the light-receiving unit 3b.

If the light-receiving unit 3b is implemented with an image sensor, the image processing unit 21d performs a predetermined image process (for example, smoothing, binarization, filtering, shading compensation or the like) on the reception result at the light-receiving unit 3b provided from the read control unit 21c.

The identification unit 21e compares data obtained by image processing in the image processing unit 21d with the reference data stored in a non-volatile storage device such as the NVRAM 20d. By doing so, the identification unit 21e determines whether or not a valid identifier 17 is contained in the image-processed data based on the light reception result from the light-receiving unit 3b. Thus, it is possible to determine whether or not the rolls 13 and 16 are legitimate products having the valid identifier 17 provided thereto.

The abnormality control unit 21f performs a predetermined operation in response to the determination results in the identification unit 21e. For example, upon selection of the secure mode as described above, the abnormality control unit 21f controls the print control unit 21a not to perform print processing any longer. Further, the abnormality control unit 21f allows the output unit controller 20h to control the output unit 18 so that the output unit 18 outputs an indication of an abnormality. For example, in one embodiment, if the output unit 18 is implemented with a display, a message indicative of disabling the print processing because the paper roll 13 or the ribbon roll 16 is not a legitimate product, is displayed on the display.

The read-write processing unit 21g is operable to write and read (e.g., access) various kinds of information to and from a storage device such as the NVRAM 20d. In one embodiment, the read-write processing unit 21g corresponds to a read processing unit and a write processing unit.

On the other hand, upon selection of the alarm mode as described above, the abnormality control unit 21f allows the output unit controller 20h to control the output unit 18 so that the output unit 18 outputs an indication of an abnormality. For example, in one embodiment, if the output unit 18 is implemented with a display, a message representing that the roll 13 or 16 is a counterfeit, or indicating that the use of such a counterfeit may deteriorate the print quality, is displayed on the output unit 18.

Further, in one embodiment, information indicative of the identification results at the identification unit 21e (i.e., identification result information) is stored in the NVRAM 20d. The information is retained at least until the rolls 13 and 16 are replaced with new ones. For example, as a sensor for detecting a replacement of the rolls, a push switch (not shown), which is pushed down by the rolls 13 and 16 or attachment thereof, may be mounted in a location at which the rolls 13 and 16 are loaded. The replacement of the rolls detected by the sensor (for example, turning ON→OFF→ON of the push switch) triggers the CPU 20a to perform a series of operations for identifying the identifier 17, including an irradiation, light-reception, image processing, identification, abnormality processing, storing (updating) the identification result information, and the like. Alternatively, the CPU 20a performs the above series of operations by recognizing the replacement of the rolls 13 and 16 based on user instructions provided from the input unit 19.

Furthermore, the CPU 20a obtains information on lengths of strip-shaped paper and ribbon wound around the respective rolls 13 and 16 based on the identifier 17. The CPU 20a acquires information indicative of the lengths from, for example, information contained in the identifier 17 or information stored in the NVRAM 20d which is associated with the information contained in the identifier 17. In addition, the CPU 20a determines the lengths of discharged portions of strip-shaped paper and ribbon (wound around the rolls 13 and 16, respectively) based on the number of rotations of the motor 14 counted since the rolls are loaded into the printer 1. The CPU 20a further compares the lengths of the discharged portions with the respective total lengths of strip-shaped paper and ribbon, thereby obtaining the lengths of remaining portions of strip-shaped paper and ribbon wound around the rolls 13 and 16. In one embodiment, the CPU 20a stores and maintains the identification result information obtained at the identification unit 21e in the NVRAM 20d at least until any one of the strip-shaped paper and ribbon is completely discharged from the rolls 13 and 16. The CPU 20a controls the printer 1 to stop printing upon confirming that any one of the lengths of the remaining lengths becomes zero, and resumes the printing upon detecting a new identifier. For example, if the CPU 20a determines that the length of a printable portion of the ink ribbon 7 is 100 meters, the CPU 20a performs printing until 100 meters of the ink ribbon 7 is discharged from the roll 16, and may not print further. In some embodiments, the CPU 20a may not perform the printing if it fails to obtain the information for the lengths of the strip-shaped paper and ribbon.

As stated above, in the present embodiment of the printer 1, the optical unit 3 is operable to read the invisible identifier 17 provided on the ribbon roll 16 wound with the ink ribbon 7 and the paper roll 13 wound with the strip-shaped paper 2, or the invisible identifier 17 provided on the ink ribbon 7 or the strip-shaped paper 2 which are discharged from respective rolls 16 and 13. The identification unit 21e checks whether the identifier 17 is valid or not. Based on the identification result, the CPU 20a changes a current operation mode or a current operation of the printer 1 (for example, switch the operation mode) or performs a predetermined operation according to the current operation mode of the printer 1 (for example, output an indication of abnormality). Therefore, according to this embodiment, it is possible to prevent counterfeiting the rolls 13 and 16, and inhibit the situation where the use of counterfeit of the rolls 13 and 16 causes malfunction of the printer 1.

As shown in FIG. 4, in one embodiment, the ribbon roll 16 wound with the ink ribbon 7 is wound around a paper core 16b. A discharge-start portion 16a of the ribbon roll 16 is fixed to another paper core 16c by for example, an adhesive. The identifier 17A is provided on a non-print in-service area (e.g., a read area) An that is not used for printing, which is positioned more adjacent to the discharge-start portion 16a than a leading end of a print in-service area (e.g., a ribbon area) Ap that is used for printing, in the ink ribbon 7. Specifically, the identifier 17A is provided on a side of the discharge-start portion 16a from a boundary 16d between the areas An and Ap. Therefore, according to this embodiment, it is possible to effectively and easily attach the identifier 17A on the ink ribbon 7 by effectively using the non-print in-service area An without unnecessarily using the print in-service area Ap.

On the other hand, as shown in FIG. 5, in one embodiment, the paper roll 13 wound with the strip-shaped paper 2 is wound around a paper core 13a. The identifier 17B is provided on an outer surface (e.g., a non-print in-service surface) 2b of the strip-shaped paper 2, which is positioned on the side opposite to the inner surface 2a (e.g., a print in-service surface) of the strip-shaped paper 2. Therefore, according to this embodiment, it is possible to further effectively provide the identifier 17B on the strip-shaped paper 2 by effectively using the non-print in-service surface without unnecessarily decreasing the print in-service surface. For example, the identifier 17B is provided on an outer peripheral surface of the paper roll 13 at an initial stage (i.e., before the strip-shaped paper 2 is discharged from the paper roll 13). In such case, the identifier 17B may be easily provided on the paper roll 13 at the final stage in the fabrication of the paper roll 13, which facilitates the reading of the identifier 17B.

In one embodiment, the read-write processing unit 21g may store the identification result information obtained by the identification unit 21e in the NVRAM 20d as a non-volatile storage device. As such, since the identification result information is determined by the identification unit 21e and maintained in the NVRAM 20d, there is no need to perform further identification operation at the identification unit 21e. Furthermore, in some embodiments, the identifier 17A may be provided on an area (for example, the non-print in-service region An) in the vicinity of the discharge-start portions of the ink ribbon 7 and the strip-shaped paper 2. This allows the identification unit 21e to identify the identifier 17 at a high speed.

In one embodiment, a plurality of identifiers 17 is provided on the ink ribbon 7 and the strip-shaped paper 2. In such a case, the plurality of identifiers 17 is provided on ink ribbon 7 or the strip-shaped paper 2 in a longitudinal direction or a lateral direction in a distributed manner. Thus, it is possible to perform identification of the plurality of identifiers 17 in a fast and effective manner. In some embodiments, a marker (for example, a character or a symbol) indicative of a position where the ink ribbon 7 and the strip-shaped paper 2 are to be loaded in the main body 1a of the printer 1, may be provided on the ink ribbon 7 and the strip-shaped paper 2. Further, information on the method of loading the ribbon and paper may be described on the ribbon and paper. The CPU 20a allows the motor controller 20j to control the motor 14 so that the optical unit 3 reads the identifier 17. That is, the motor controller 20j controls the motor 14 to perform forward/backward feeding of the ink ribbon 7 or the strip-shaped paper 2, which enables the optical unit 3 to read the identifier 17 while feeding the ink ribbon 7 or the strip-shaped paper 2.

Furthermore, in this embodiment, the read-write processing unit 21g reads information associated with the identifier 17 from the NVRAM 20d. Based on the read information, the CPU 20a performs a predetermined operation according to a current operation mode or changes the operation mode. This may minimize the amount of information to be contained in the identifier 17, thereby making a configuration of the identifier 17 simple.

As shown in FIGS. 4 and 5, in one embodiment, the identifier 17 may be a bar code. In such a case, the bar code is associated with control information (for example, a print concentration, a print pulse width, a rotation speed of the motor 14 or the like) for the ink ribbon 7 and the strip-shaped paper 2, which may be stored in a storage device such as the ROM 20b or the NVRAM 20d. Thus, the CPU 20a of the printer 1 obtains the control information corresponding to the ink ribbon 7 and the strip-shaped paper 2, which are mounted in the printer 1. This enables the print control unit 21a to control the print concentration, the print pulse width, the rotation speed of the motor 14 in the printer 1 to be adjusted to proper conditions for the ink ribbon 7 and the strip-shaped paper 2. Further, in some embodiments, attribute information of the ink ribbon 7 and the strip-shaped paper 2 may be stored in the storage device. The attribute information may be associated with the bar code and include retailer identification, manufacturer identification, a model number, a lot number, a product code, a product specification (width, length, thickness, etc.), a manufacturer location, a manufacturing date or the like. This enables the CPU 20a to obtain the attribute information corresponding to the ink ribbon 7 or the strip-shaped paper 2. Further, in one embodiment, the identifier 17 may be implemented with one-dimensional barcode as shown in FIGS. 4 and 5, which makes the configuration of the light-receiving unit 3b simpler. As shown in FIGS. 4 and 5, for the one-dimensional barcode, bars in the barcode may be arranged along a direction perpendicular to the feed direction of the ink ribbon 7 and the strip-shaped paper 2. This enables the light-receiving unit 3b to sequentially read the bar code as the ink ribbon 7 and the strip-shaped paper 2 move forward. This allows reading of the bar code even if the light-receiving unit 3b of a relatively small size is employed. In FIGS. 4 and 5, for the sake of clarity, the identifier 17 with the bar code is shown explicitly, while in actual implement, the identifier 17 is invisible under visible light.

Furthermore, in one embodiment, the light-receiving unit 3b may be implemented with an image sensor, which allows more information to be stored in the identifier 17. For example, in this case, the identifier 17 may contain a two-dimensional bar code, or at least one of a character, a symbol, a pattern, an image or the like. In such a configuration, the CPU 20a obtains control information or attribute information for the ink ribbon 7 and the strip-shaped paper 2 directly from the identifier 17, which reduces the capacity of the storage device that is necessary for storing such information. In this case, the CPU 20a may perform a function (OCR: Optical Character Recognition) for recognizing a character or a symbol off image data on the identifier 17.

While certain embodiments have been described, these embodiments have been presented by way of example only, and are not intended to limit the scope of the inventions. Indeed, the embodiments described herein may be embodied in a variety of other forms. For example, a location at which an identifier is provided on a web material, or a location at which an optical unit is mounted within a printer, may be changed without departing from the spirit of the inventions. Furthermore, a specification (a scheme, structure, shape, size, length, depth, thickness, cross-section area, weight, number, material, arrangement, location, wavelengths of light or the like) of each component (a print unit, main body, identifier, roll holding unit, roll, web material, irradiation unit, light-receiving unit, identification unit, optical unit, print in-service area, non-print in-service area, print in-service surface, non-print in-service surface, bar code, image sensor or the like) may be modified in a variety of other forms. Furthermore, while the non-volatile storage device is implemented by a NVRAM, but not limited thereto. In one aspect of the present disclosure, a printer may perform printing on an continuous-form paper, for example, a folded paper such as a fanfold paper on which an invisible identifier is provided.

The accompanying claims and their equivalents are intended to cover such forms or modifications as would fall within the scope and spirit of the inventions.

What is claimed is:

1. A printer, comprising:
a roll holding unit configured to hold a roll wound with a web material;
an irradiation unit configured to irradiate light on at least a portion of the web material wound around the roll;
a light-receiving unit configured to receive light reflected from the at least a portion of the web material;
an identification unit configured to identify whether an identifier is provided on the web material and whether the identifier is valid, based on the light reception result of the light-receiving unit;
a control unit, in response to the identification results of the identification unit, configured to perform a predetermined operation according to an operation mode or change the operation mode; and
a print unit configured to print on a printing medium based on the operation mode.

2. The printer of claim 1, wherein the printing medium is provided on the web material.

3. The printer of claim 1, wherein the web material is an ink ribbon.

4. The printer of claim 1, wherein the web material is paper.

5. The printer of claim 1, wherein the identifier is provided on a non-print in-service area which is positioned more adjacent to a discharge-start portion of the web material than a leading end of a print in-service area in the web material.

6. The printer of claim 1, wherein the identifier is provided on a non-print in-service surface of the web material, the non-print in-service surface being positioned opposite to a print in-service surface of the web material.

7. The printer of claim 1, further comprising: a write processing unit configured to allow the identification results of the identification unit to be stored in a non-volatile storage device.

8. The printer of claim 1, further comprising: a read processing unit configured to access information associated with the identifier from a non-volatile storage device,
wherein the control unit is configured to perform the predetermined operation according to the operation mode or change the operation mode based on the information accessed by the read processing unit.

9. The printer of claim 1, wherein the web material includes a plurality of identifiers provided in a distributed manner.

10. The printer of claim 1, wherein the web material includes a continuous-form paper without a backing sheet.

11. The printer of claim 1, wherein the roll holding unit is configured to rotatably hold the roll wound with the web material.

12. The printer of claim 1, wherein the identifier is provided with an invisible ink having at least one of infrared absorbency, infrared reflectivity and fluorescence.

13. The printer of claim 1, wherein the identifier is provided on an outer peripheral surface of the roll.

14. The printer of claim 1, wherein the operation mode comprises:
a secure mode in which the printing is performed only if the identifier is determined to be valid;
an alarm mode in which an indication of abnormality is output if the identifier is not valid; and
a normal mode in which the printing is performed irrespective of the identification results of the identification unit.

15. The printer of claim 14, wherein the identification results are stored in a non-volatile storage device at least until the roll is replaced with new one.

16. A roll wound with a web material with an identifier provided thereon, for use in a printer, the printer comprising:
a roll holding unit configured to hold the roll;
an irradiation unit configured to irradiate light on at least a portion of the web material;
a light-receiving unit configured to receive light reflected from the at least a portion of the web material;
an identification unit configured to identify whether an identifier is provided on the web material and whether the identifier is valid, based on the light reception result of the light-receiving unit;
a control unit, in response to the identification results of the identification unit, configured to perform a predetermined operation according to a current operation mode or change the current operation mode; and
a print unit configured to print on a printing medium based on the current operation mode.

17. The roll of claim 16, wherein the identifier is implemented with an invisible ink having at least one of infrared absorbency, infrared reflectivity and fluorescence.

18. The roll of claim 16, wherein the identifier is provided on an outer peripheral surface of the roll.

19. A printer, comprising:
a roll holding unit configured to hold first and second rolls wound with different web materials, each rotating in the same direction;
an irradiation unit configured to irradiate light on at least a portion of each of the different web materials;
a light-receiving unit configured to receive light reflected from each of the web materials;
an identification unit configured to identify whether an identifier is provided on each of the web materials and whether each identifier is valid, based on a respective light reception result of the light-receiving unit;
a control unit, in response to the identification results of the identification unit, configured to control an operation mode of the printer; and
a print unit configured to print on a printing medium based on the operation mode.

20. The printer of claim 19, wherein the web materials include a plurality of identifiers provided thereto in a distributed manner.
